(19) United States
(12) Patent Application Publication
(10) Pub. No.: US 2022/0270451 A1
(43) Pub. Date: Aug. 25, 2022

(54) CASEMENT WINDOW HANDLE SENSOR

(71) Applicant: MIGHTON PRODUCTS LIMITED, Saffron Walden (GB)

(72) Inventor: Michael DERHAM, Saffron Walden (GB)

(73) Assignee: MIGHTON PRODUCTS LIMITED, Saffron Walden (GB)

(21) Appl. No.: 17/595,595

(22) PCT Filed: May 21, 2020
(86) PCT No.: PCT/GB2020/051242

§ 371 Date: Nov. 19, 2021

(30) Foreign Application Priority Data
May 21, 2019 (GB) 1907164.6

(51) Int. Cl. G08B 13/08; E05B 1/00; G08B 25/10; G08B 29/04

(52) U.S. Cl. CPC G08B 13/08; E05B 1/003; G08B 25/10; G08B 29/04; E05B 2045/0665

(57) ABSTRACT

A sensor system to reliably alert and inform a user of the status of a window, in particular, a sensor system which reliably informs the user if the window is both in a closed position and also that the locking mechanism is in the locked configuration. There are thereby provided two independent sensor systems within the casement window handle assembly which are arranged to verify that the window handle is in the locked configuration and also that the window sash is in the closed position relative to the window frame. The casement window handle assembly comprises a first sensor for indicating the position of the window handle and this comprises a first sensor component mounted to the pivotal/movable handle and a second component fixed within the mounting base.

### FIELD OF THE INVENTION

The present invention relates to a casement window handle sensor, a window assembly comprising a casement window handle sensor and a method of detecting and/or monitoring the status of a casement window sash within a window frame.

### BACKGROUND TO THE INVENTION

Security systems often include sensors to detect the unauthorised opening of a window, for example, during a burglary. Such sensors are generally located on the edge of the window located distally from the pivot with a corresponding sensing device being mounted on the window frame. As the window is pivoted towards an open position, the sensor is activated and an alarm signal may be generated. Such an alarm signal generally consists of a loud audible alarm which provides an alert to the property owner (or surrounding inhabitants) and also acts to scare the intruder due to the awareness of the unauthorised act having been detected.

Such alarms can be trigger inadvertently and these audible alarms may no longer attract the attention of surrounding unconnected people. Accordingly, an intruder may now continue with the unauthorised access in the knowledge that the alarm may not attract the attention of any unconnected people. In addition, the property may be located in a remote position with few, if any, surrounding people.

Many people now simply assume that an alarm is a false alarm and will not necessarily act on the triggering of an alarm system. This may be particularly relevant if such an alarm system has previously been triggered with a false alarm situation.

Accordingly, such alarm systems must be very robust to prevent false alarms and/or the alarm signal must be transmitted to the responsible person or surveillance person. Such people may be located remote from the location and a transmission method will therefore be required.

In addition, these alarm systems for use with windows provide a simple check on whether the window is actually open or closed and no further information with regards to the status of the window is available.

Property owners may want to confirm the status of the property and, for example, may want to ensure that all the doors/windows are closed and/or locked, or the lights are off (or on, as required), the status of any appliances etc. Such a status check generally requires a user to individually check each item or appliance. This can be time consuming and laborious and also is impractical in many situations.

As mentioned above, alarms are frequently used throughout establishments to monitor and detect unauthorised entry or potential access to a building. Such alarms generally comprise a central control system which communicates with several individual detectors placed strategically throughout the property. For example, the detector may include a movement sensor placed within an upper location of a room which would detect movement within the room.

The alarm is activated at a central activation point and following this, the detectors may then send signals to provide alerts of unauthorised movement etc. The control system may provide an audible alarm and/or a remote alert system whereby an appointed user or security company and/or a relevant authority is alerted to unexpected activity.

The detectors in such an alarm system may also be configured to show the status of a door or window and may confirm whether the window/door is open or closed.

Such window and door sensors generally comprise a proximity sensor which will alert the user as to whether the door or window sash is located adjacent to the relative frame and thereby in a closed position. Alternatively, the detector may be arranged to show that the handle of the window is in the closed position to provide an indication that the window is secure.

However, there is a risk of an incorrect status being interpreted from the results of the detector in that the window may not actually be in a secured position even though the alarm system through the relevant detector shows that it is closed/locked/secured.

It is an aim of the present invention to overcome at least one problem associated with the prior art whether referred to herein or otherwise.

### SUMMARY OF THE INVENTION

According to a first aspect of the present invention there is provided a casement window handle comprising:
a mounting base, and
a window handle

wherein the window handle is movable between a latched position and an unlatched position, the mounting base being arranged to be mounted to part of a window sash movably mounted within a window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.

The first handle component may comprise a magnet and preferably comprises a neodymium magnet.

The rotatable member may comprise a rotatable boss. The rotatable member may comprise a (rotatable) spindle. The spindle may comprise a non-ferrous spindle.

The spindle may extend between the window handle and a window sash locking mechanism. The spindle may be bonded to the window handle. The spindle may have a square cross section.

The rotatable boss may comprise a passageway defined therethrough which is arranged to engage (or encapsulate) an outer periphery of a spindle.

Preferably a first end of the spindle is engaged with the window handle and the second (opposite) end is engaged with a window sash locking mechanism. The window sash locking mechanism may comprise an espagnolette lock.

The rotatable member (boss/spindle) may comprise a retaining recess within which the magnet is retained. The retaining recess may be defined in an outer circumferential surface of the rotatable member (boss/spindle).

The magnet may comprise a cylindrical magnet. The retaining recess may comprise a cylindrical recess. The magnet may be retained with a planar outer (circular) face facing outwardly from the outer circumferential surface of the rotatable member (boss/spindle). In the latched position, the planar outer face may directly face the second handle component. The cylindrical magnet may have a central longitudinal axis wherein the central longitudinal axis is provided on a radius of the rotatable member (boss/spindle). Accordingly, the magnet may be movable around a coincidental path on the rotatable member (boss/spindle). The magnet may be angularly movable between the latched position and the unlatched position.

The second handle component may comprise a reed switch. The reed switch may be mounted on a printed circuit board mounted with a housing of the mounting base.

The reed switch may be angularly positioned and/or may be perpendicularly positioned relative to the longitudinal axis of the magnet in the latched (or unlatched) position. The reed switch may be substantially parallel or at an (acute) angle relative to the longitudinal axis of the magnet in the unlatched (or latched) position. The reed switch may extend along a longitudinal axis which may be angularly positioned and/or may be perpendicularly positioned relative to the longitudinal axis of the magnet in the latched (or unlatched) position. The reed switch may extend along a longitudinal axis which may be substantially parallel or at an (acute) angle relative to the longitudinal axis of the magnet in the unlatched (or latched) position.

The first window component may comprise a reed switch. The reed switch may be mounted on a printed circuit board mounted with a housing of the mounting base.

The second window component may a comprise magnet which may be located within a discrete housing which may be separate and independent of the window handle (mounting base). The second window component may comprise a neodymium magnet.

The casement window handle may comprise communication means to communicate signals from each sensor to a remote unit. Preferably the communication means comprises a Bluetooth communication means.

The communication means may be arranged to be connected to a control hub (control means). The control hub (control means) may be connected to a router in order to further communicate the signal from the casement window handle.

The signals may be communicated directly (or indirectly through the hub) to a smart phone.

The control means (control hub) may combine the signals received from both sensors to determine if the window sash is in a secure status or an unsecured status.

The secured status may be identified when both sensors indicate that the window sash is closed within the window frame and the window handle is in a latched position. The unsecured status may be identified when either the window sash is open within the window frame or the window handle is in the unlatched position or both.

The casement window handle may comprise an impact sensor. The impact sensor may be arranged to sense (and detect) an impact on the window and/or casement window handle.

The impact sensor may comprise a shock sensor.

The impact sensor may be arranged to monitor impacts on the window and/or casement window handle.

The control means (control hub) may be arranged to receive the signals from the impact sensor and analyse (screen) the signal to identify an unauthorised attack from a signal generated by use or the environment (for example wind, natural vibrations etc.). The control means may monitor the frequency of signals received from the impact sensor. The control means may monitor (quantify) a strength of impact received from the impact sensor. The control means may monitor the time duration (and/or count/number) of signals received from the impact sensor.

The impact sensor may comprise a MEMS device and may comprise an accelerometer.

The casement window handle may comprise a housing.

The housing may comprise power means. The power means may comprise a battery. The power means may comprise one and preferably two button batteries.

The housing may contain transmission means and preferably comprises a Bluetooth transmitter.

The housing may comprise a self contained unit which includes the sensor components, the transmission means and power means.

According to a second aspect of the present invention there is provided a window assembly comprising a window sash, a window frame and a casement window handle comprising:
a mounting base, and
a window handle

wherein the window handle is movable between a latched position and an unlatched position, the mounting base being arranged to be mounted to part of the window sash movably mounted within the window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.

According to a third aspect of the present invention there is provided a home automation system comprising at least one window status sensor system for monitoring a window including a casement window handle, the casement window handle comprising:
a mounting base, and
a window handle

wherein the window handle is movable between a latched position and an unlatched position, the mounting base being arranged to be mounted to part of a window sash movably mounted within a window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.

According to a fourth aspect of the present invention there is provided a method of providing a window status sensor system, in which a window includes a casement window handle, the casement window handle comprising:
a mounting base, and
a window handle

wherein the window handle is movable between a latched position and an unlatched position, the mounting base being arranged to be mounted to part of a window sash movably mounted within a window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.

### BRIEF DESCRIPTION OF THE DRAWINGS

The present invention will now be described by way of example of only, with reference to the drawings that follow, in which:

FIG. 1 is a perspective view of a preferred embodiment of a casement window handle;

FIG. 2 is an exploded view of a preferred embodiment of a casement window handle;

FIG. 3 is an exploded view of a preferred embodiment of a casement window handle;

FIG. 4 is a side exploded view of a preferred embodiment of a casement window handle;

FIG. 5 is a rear view of an internal portion of a preferred embodiment of a casement window handle;

FIG. 6 is a perspective view of a preferred embodiment of a casement window handle installed to a casement window;

FIG. 7 is a perspective view of a preferred embodiment of a casement window handle installed to a casement window; and

FIG. 8 is a perspective view of another preferred embodiment of a casement window handle;

FIG. 9 is a perspective view of another preferred embodiment of a casement window handle with the battery hatch removed;

FIG. 10 is a perspective view of another preferred embodiment of a casement window handle with the battery hatch and batteries removed;

FIG. 11 is a side view of part of another preferred embodiment of a casement window handle;

FIG. 12 is a perspective view of part of another preferred embodiment of a casement window handle;

FIG. 13 is a perspective view of part of another preferred embodiment of a casement window handle;

FIG. 14 is a perspective view of a handle spindle and associated reed switch of another preferred embodiment of a casement window handle; and

FIG. 15 is a perspective view of a handle spindle and associated reed switch of another preferred embodiment of a casement window handle.

### DESCRIPTION OF THE PREFERRED EMBODIMENTS

The present invention provides a window status sensor system which may be of particular use with a casement window of a domestic property. The window status sensor system may cooperate with or may be integrated into a home automation system. In such a home automation system, a user may be able to monitor and/or control several items throughout the property. For example, a user may be able to monitor and/or control numerous domestic parameters such as the status of a light, the status of a domestic appliances, the condition/status of a smoke detector, the level of an oil tank etc. The home automation system may also be linked to the thermostat and may also be linked to cameras within or around the property. Such a home automation system may include a (control) hub (control means) and may be controlled by and monitored on a smartphone, tablet, remote PC etc.

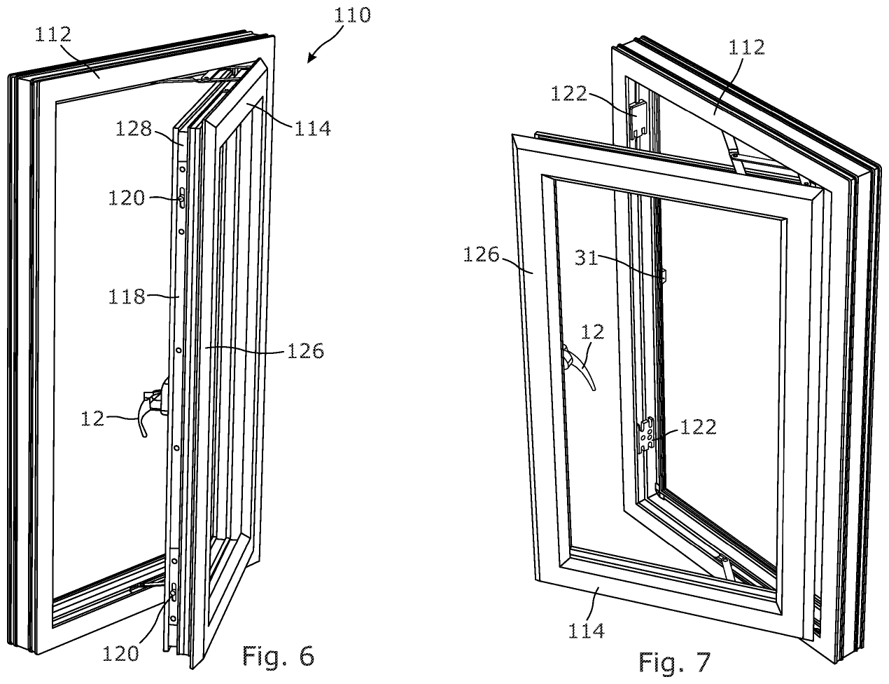

A typical casement window 110 comprises a window frame 112 and a pivotally mounted window sash 114, as shown in FIG. 6 and FIG. 7. The casement window 110 has hinges in order to pivotally mount the window sash 114 in the window frame 112. The hinges are configured to enable the window to pivot about a vertical axis such that the window sash 114 is retained in a vertical plane. Accordingly, the window sash 114 is arranged to open outwardly from one side of the window frame 112. However, it will be appreciated that the window status sensor system could be used with other types and styles of windows.

The casement window 110 includes a locking mechanism in order to lock the window, i.e. to lock the window sash 114 to the window frame 112 in a closed position. The locking mechanism comprises a locking handle 12 which is coupled to a locking rod 118 and such a locking mechanism comprises an espagnolette locking device. The locking rod locates in a Eurogroove 128 (or equivalent, for example, the US equivalent) provided along the outer edge of the window sash 114. The locking mechanism may or may not require a dedicated key and the use of such a dedicated key is seen as a secondary lock mechanism, i.e. the term “lock” in accordance with the present invention equates to retained/secured/engaged such that the window may still be openable without the use of a key. However, in some embodiments a key may be required and this provides a further level of security. In particular, the key locking mechanism may (directly) prevent rotation of the locking handle and this thereby prevents the window from being opened. The locking handle may only be mounted internally (i.e. no external locking handle) and, therefore, when the window is closed and the espagnolette locking rod engaged, this effectively locks the window and prevents a person from opening the window from outside.

The locking handle 12 is mounted to the inside of the outer rail 126 of the window sash 114. The locking handle 12 is coupled to the locking rod 118 by a coupling mechanism such that the rotational movement of the locking handle 12 causes translational movement of the locking rod 118. The locking rod 118 is located on the outer edge of the outer rail 126 of the window sash 114 and the locking rod 118 is retained to slidably move up and down this outer edge.

The locking rod 118 has a number of locking elements comprising locking lugs 120 which are arranged to project outwardly from the locking rod 118. These locking lugs 120 may comprise locking bolts or locking pegs etc.

The movement of the locking rod 118 thereby causes movement of these locking lugs 120 upwardly and downwardly relative to the window sash 114 and the window frame 12.

The locking mechanism further includes keeps 122 which are arranged to accept and retain the locking lugs 120 in the locked configuration. In particular, each keep 122 includes at least one locking slot 124 into which a locking lug 120 can be slidably moved. As mentioned above, this movement is caused through the action of the rotation of the locking handle 116 causing the translational movement of the locking rod 118.

When the casement window 110 is in a closed but unlocked position, the locking lugs 120 are disengaged with the locking slots 124 of a respective keep 122. In order to lock the window 110, the locking handle 116 is rotated and the locking rod 118 is slidably moved in order to move the locking lugs 120 into respective locking slots 124 within a keep 122. In this configuration, the window sash 114 is both closed and locked, i.e. a user could not simply push the locking handle 12 or window sash 114 in order to open the window 110. The casement window 110 may be provided with a key mechanism in order to actively lock the casement window 110 in this configuration. In particular, the locking handle 12 may have a key locking mechanism to prevent rotation of the handle 12 unless the key 16 has unlocked this mechanism.

Prior art sensor systems are available to detect whether a window 110 is open or closed. However, unfortunately, many windows 110 may simply be closed without the locking mechanism having been correctly set. For example, a window sash 114 may simply be pushed to a closed position or may be closed by the action of wind such that the locking lugs 120 are not actually engaged in the locking slots 124. Such windows 110 have the appearance (i.e. by a visual inspection or by a prior art simple sensor system) of being correctly shut but the window 110 could actually be opened by a user simply pushing on the window sash 114. Accordingly, such signals give a false representation of the protection offered by the status of the window.

The present invention provides a window status sensor system which provides positive feedback on the position of the handle 12 and the position of the window sash 114. In particular, the present invention provides a signal concerning the position of the sash 114 and also the position of the handle 12. Accordingly, a user will know that the window 110 is actually closed and locked rather than being merely in a closed position or merely with the handle 12 in a locked position.

The window status sensor system detects and monitors the actual positions of both the handle 12 and the window sash 114 rather than just monitoring the position of the window sash 114 or the locking handle 12 etc. Accordingly, this feedback provides positive reassurance that the locking lugs 20 are actually in an engaged/locked position.

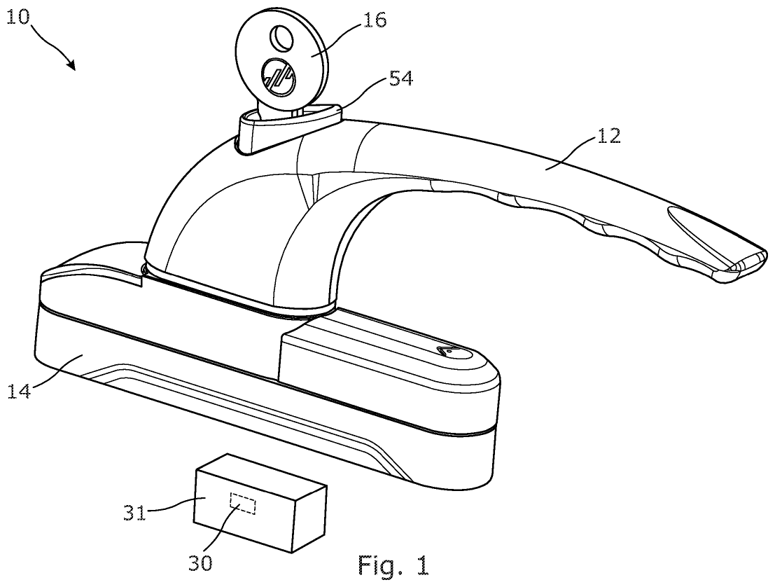

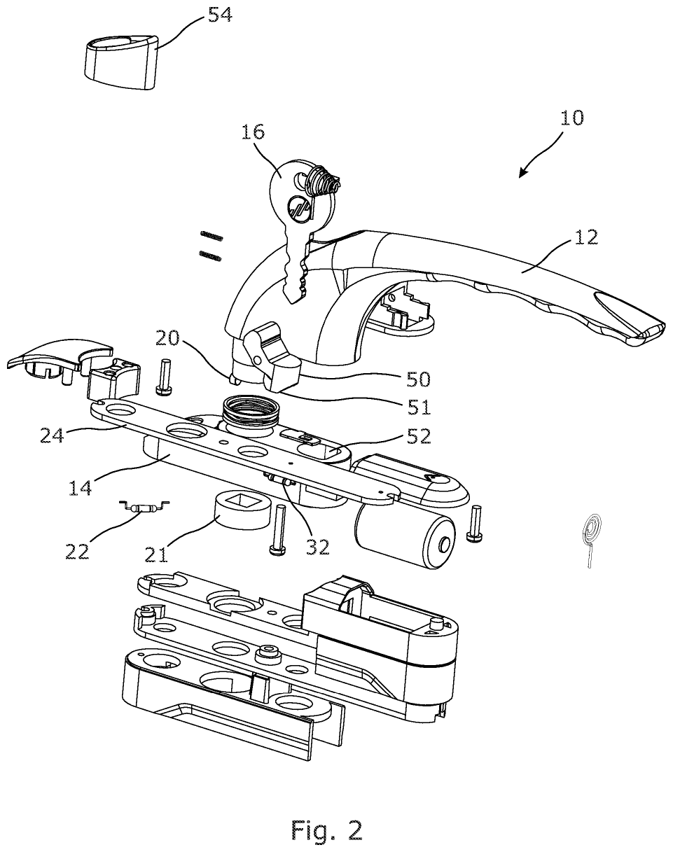

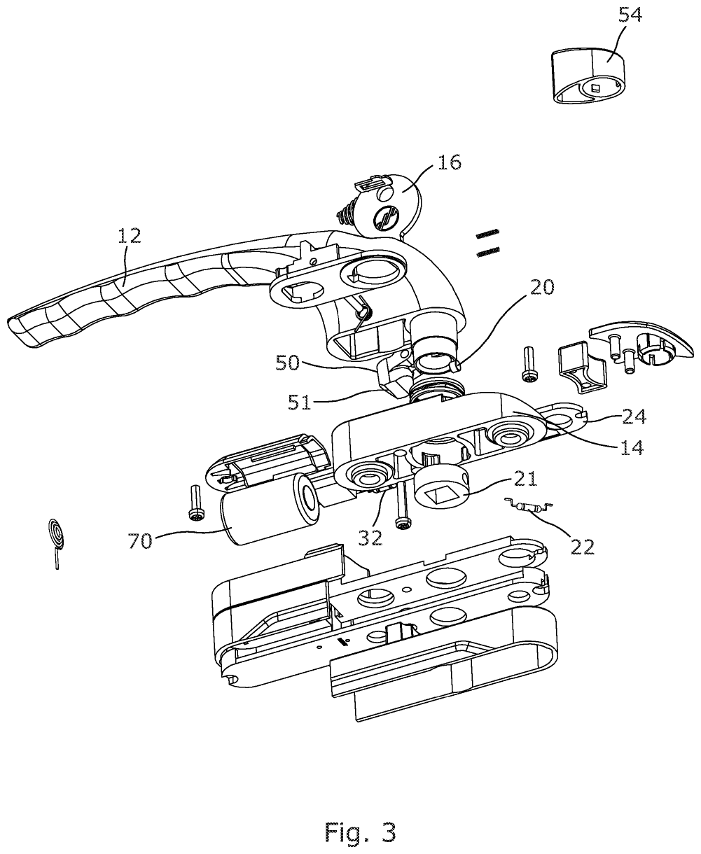

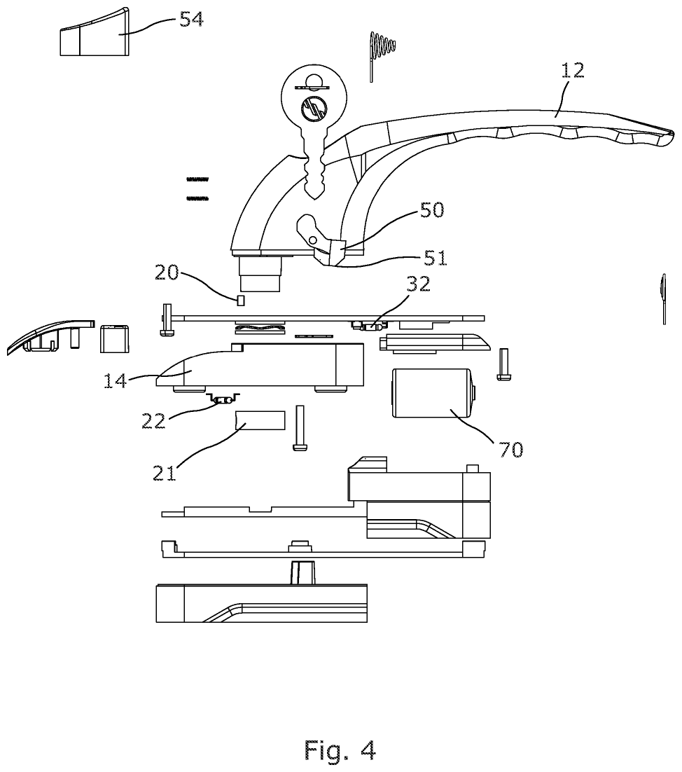

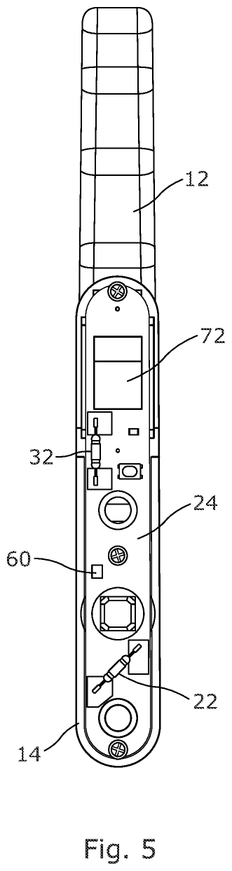

As shown in FIG. 1 to FIG. 5, the casement window handle assembly 10 comprises a handle 12 and a mounting base 14 which is arranged to mount the assembly on a window sash 114 of a casement window 110 located within a window frame 112. The window handle 12 is movable relative to the mounting base 14 between an open position and a closed position. The window sash 114 is movable relative to the window frame 112 between an open position and a closed position and, in particular, pivots along one edge. For example, the window sash may pivot along a first side edge with the casement window handle assembly 10 being mounted on the opposite side. Alternatively, the window sash 114 may be pivotally mounted in the window frame 112 along an upper edge with the casement window handle assembly 10 being mounted along a lower edge of the window sash 114. However, it will be appreciated that other arrangements may also be suitable.

As mentioned above, the window sash 114 includes a locking mechanism such as an espagnolette mechanism which may be located along the same edge of the window sash to which the casement window handle assembly 10 is mounted. The espagnolette locking mechanism includes locking members which are slidably moved into and out of a locking position are arranged to move into a locking recess provided by the window frame in order to lock the window in a closed position. The handle 12 is pivotally mounted and moves from a first position to a second position in order to move the locking members into and out of engagement with the window frame. The window handle 12 is secured to a spindle which extends between the window handle and the espagnolette locking mechanism such that pivotal (rotational) movement of the window handle 12 to a locked position will be arranged to move the members 120 to the locked position.

Accordingly, the window handles 12 are arranged to securely lock the window sashes in a closed positon relative to the window frame. The casement window handle assembly 10 is located internally and prevents unauthorised access therethrough.

The casement window handle 10 assembly also comprises a latch mechanism including a latch member in the form of a catch 50 which is arranged to latch and engage the window handle 12 in the closed position relative to the mounting base 14. The catch 50 provides a first projecting end 51 which extends outwardly from a surface of the window handle 12. The mounting base 14 comprises a corresponding surface which provides a latching recess/opening 52 into which the projecting end 51 of the catch 50 can extend in the closed position. The projecting end 51 of the catch 50 locates within this retaining recess 52 in the closed position. In the open position, the corresponding surfaces of the window handle 12 and the mounting base 14 are angularly/pivotally spaced apart such that the projecting end 51 of the catch 50 simply extends outwardly and the retaining recess 52 is exposed.

The catch 50 is pivotally mounted and includes urging means to bias the projecting end 51 of the catch 50 outwardly. Furthermore, the projecting end 51 includes a shaped surface or edge. This shaped surface or edge is arranged to co-operate with an edge of the mounting base 14. Accordingly, as the window handle 12 pivots from an open position to a closed position the edge of the projecting end 51 abuts and contacts the corresponding edge of the mounting base 14 which forces the projecting end 51 to move inwardly into the window handle 12. Further movement of the window handle 12 to the closed position then aligns the projecting end 51 of the catch 50 with the retaining recess 52 such that there is no further contact on the projecting end 51 and the urging means of the catch 50 causes the projecting end 51 to extend into the retaining recess 52 and is retained therein. The edges and shape of the projecting end 51 and the edges/shape of the retaining recess 52 are such that movement of the window handle 12 from a closed position to an open position is not possible and is prevented by the abutment of the projecting end 51 within the walls/edges of the retaining recess 52.

The window handle 12 is provided with a push button mechanism which enables a user to manually push a button 54 to cause the projecting end 51 to be retracted into the window handle 12 and to the enable rotation of the window handle 12 from the closed position to the open position.

Furthermore, the push button 54 is provided with a locking mechanism such that the push button 54 is locked in the extended position and cannot be pushed in when the locking mechanism is engaged. Accordingly, a user is able to use a key 16 to prevent operation of the push button 54 which would then enable the release of the window handle 12 from the closed positon. The key operated locking mechanism thereby provides a further security system to prevent unauthorised access through the window.

The present invention provides a sensor system to reliably alert and inform a user of the status of a window. In particular, the present invention provides a sensor system which reliably informs the user if the window is both in a closed position and also that the locking mechanism (espagnolette locking mechanism) is in the locked configuration. One potential problem with prior art systems is to provide a sensor which simply shows that the window is not open although this would not show whether the locking mechanism is in the locked configuration. Alternatively, a prior art system may demonstrate that the window handle is in the locking position although this may have been inadvertently moved to such a position even though the window is in an open position. Accordingly, both situations would inform the user that the window was in a secure position when in fact it would be in a vulnerable and unsecured position.

The present invention thereby provides two independent sensor systems within the casement window handle assembly 10 which are arranged to verify that the window handle 12 is in the locked configuration and also that the window sash 114 is in the closed position relative to the window frame 112.

The casement window handle assembly 10 comprises a first sensor for indicating the position (or latched status) of the window handle and this comprises a first (handle) sensor component mounted to the pivotal/movable handle 12 and a second (handle) component fixed within the mounting base 14. In the preferred embodiment the fixed component is provided by a reed switch 22 located on a board (printed circuit board 24) provided within the mounting base 14. The first component comprises a magnet 20 which is housed within a rotatable boss 21 through which the spindle extends. In particular, the boss 21 provides a shaped (square) passageway through which the spindle extends such that rotation (turning) of the spindle causes rotation of the boss 21.

As the magnet 20 moves relative to the reed switch 22, the reed switch 22 is arranged to change status (e.g. from an open to a closed position or from a closed to an open position). For example, in the closed position the magnet 20 may be in a position in relatively close proximity to the reed switch 22 such that the magnet 20 moves the reed switch 22 to an open configuration. As the window handle 12 is rotated to an open position, the movement of the window handle 12 causes rotation of the spindle which causes rotation of the boss 21. This movement will cause the magnet 20 to move away from the reed switch 22 and the status of the reed switch 22 will change. The reed switch 22 is positioned on the circuit board 24 and the magnet 20 is mounted within the boss 21 to ensure these two statuses are reliably detected through the change in status of the reed switch 22.

The magnet comprises a cylindrical neodymium magnet which may have a diameter of 3 mm and a depth of 2 mm. The boss 21 provides a cylindrical retaining recess in an outer perimeter (circumferential) surface. The magnet 20 is retained in the recess with an outer planar surface facing directly outwardly (tangentially orientated) from the outer peripheral surface. The cylindrical magnet has a central longitudinal axis which extends along a radius of the boss 21. The angular position of this longitudinal axis is arranged to move with the rotation of the rotatable boss 21.

The reed 22 switch has a longitudinal axis which is arranged at an angle relative to the radius of the boss 21. In the closed position, the longitudinal axis of the cylindrical magnet will dissect (or bisect) the reed switch 22 and the respective longitudinal axes will cross over each other. In the open positon, the longitudinal axis of the cylindrical magnet is rotated and in the fully open position the longitudinal axis of the magnet 20 will be parallel to the longitudinal axis of the reed switch 22. This ensure a reliable open and closing force for the reed switch and reliably discriminates between the two states and provides an accurate status signal.

Accordingly, the first sensor will alert a user as to whether the locking (latching) mechanism is in a locked (latched) position or an unlocked (unlatched) position. As mentioned above, this does not guarantee that the window is in a closed position since the window sash may in fact be locked in an open position. The casement window handle assembly 10 thereby provides a second sensor comprising a first (window) sensor component mounted within the mounting base 14 and a second (window) sensor component is mounted on the window frame 112 itself. The sensor provides a proximity sensor which will demonstrate if the two sensor components are located adjacent to each other or are spaced apart which would indicate that the window sash 114 is in an open position within the window frame 112.

In the preferred embodiment, the mounting base 14 includes a second reed switch 32 mounted adjacent to one side on the printed circuit board 24. The casement window handle assembly 10 includes a discrete sensor component (housing) 31 which is arranged to be independently secured to the window frame 112 and houses a magnet 30 which is positioned to change the status of the reed switch 32 when the window sash 114 is closed within the window frame 112.

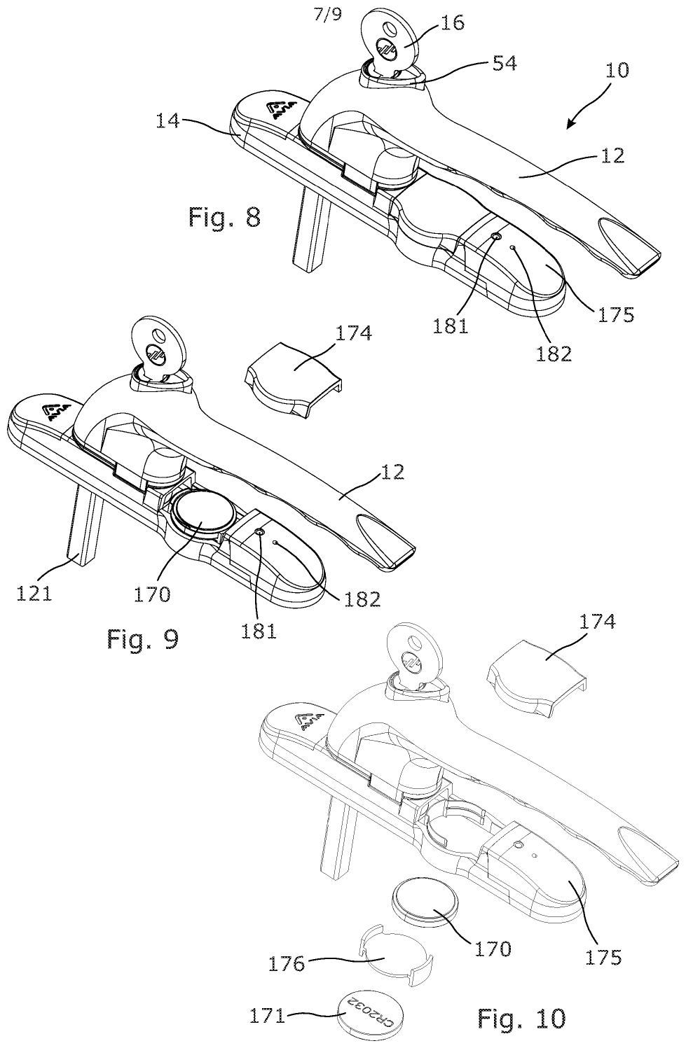

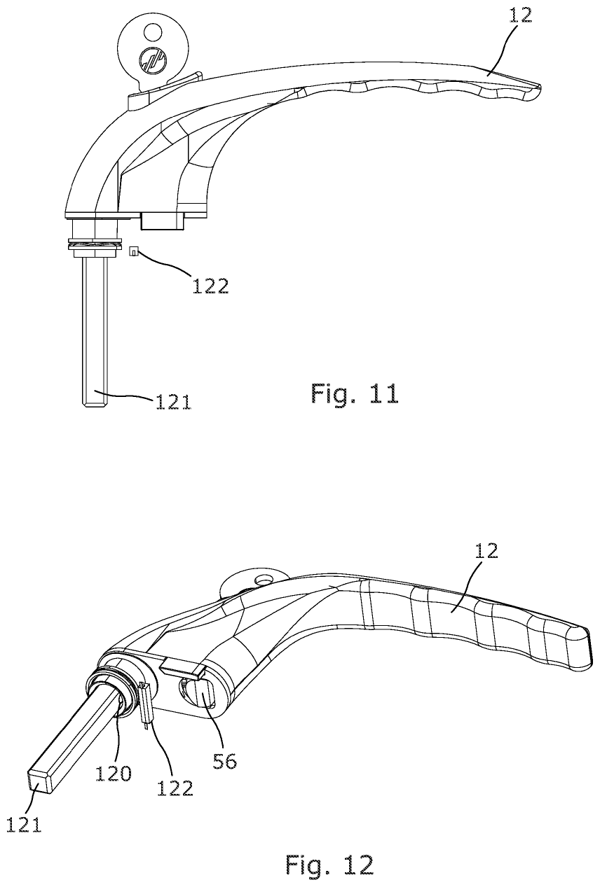

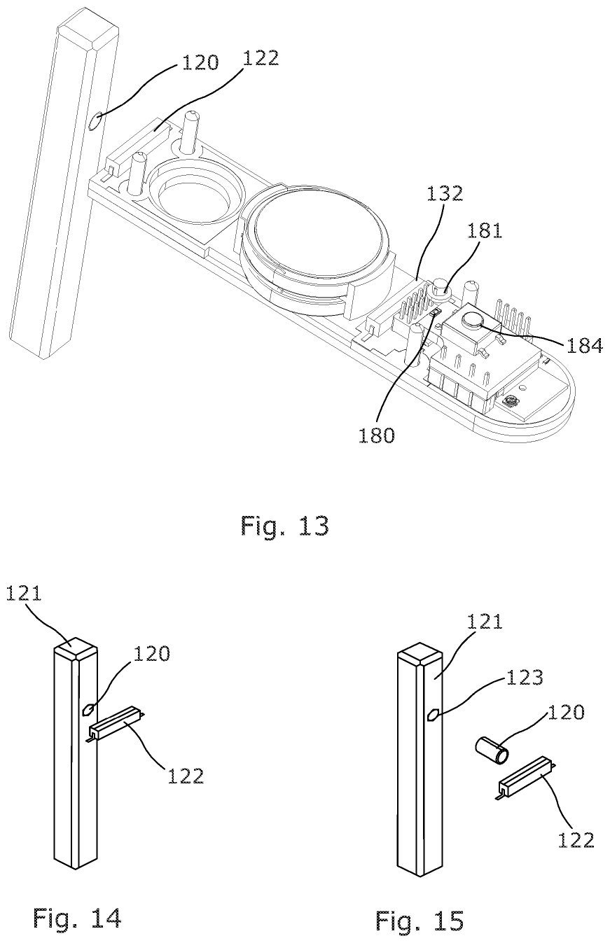

As shown in FIG. 8 to FIG. 15, in another preferred embodiment of the casement window handle assembly 10, the power means comprises a button battery 170, 171. In particular, the power means comprise a first button battery 170 and a second button battery 171 to extend the available power duration available from the battery supply. The two batteries 170, 171 are located beneath a removable battery hatch 174/cover. A battery holder 176/divider is provided to house the two batteries 170, 171 within the battery compartment in the required configuration.

In this embodiment, the first sensor for indicating the position (or latched status) of the window handle utilises a different first (handle) sensor component mounted to the pivotal/movable handle 12 and still utilises a similar second (handle) component fixed within the mounting base 14. In this embodiment the fixed component is provided by a reed switch 122 located on a board (printed circuit board 24) provided within the mounting base 14. The first component comprises a magnet 120 which is housed/secured within a rotatable (turnable) spindle 121. In particular, the square cross-sectional spindle 121 provides a shaped recess 123 (aperture/passageway) into which the magnet 120 is housed. Accordingly, rotation of the handle 12 causes rotation of the spindle 121 which thereby rotates (and re-orientates) the magnet 120 relative to the reed switch 122.

In accordance with the earlier embodiment, as the magnet 120 moves relative to the reed switch 22, the reed switch 122 is arranged to change status (e.g. from an open to a closed position or from a closed to an open position). For example, in the closed position the relevant pole of the magnet 120 may be in a position in relatively close proximity to the reed switch 122 such that the magnet 120 moves the reed switch 122 to an open configuration. As the window handle 12 is rotated to an open position, the movement of the window handle 12 causes rotation of the (square) spindle and hence the change in relative position and orientation of the magnet 120 (and the relevant pole). This movement will cause the magnet 120 (or at least the relevant pole) to move away from (or towards) the reed switch 122 and the status of the reed switch 122 will change. The reed switch 122 is positioned on the circuit board 24 and the magnet 120 is mounted within the spindle 121 to ensure these two statuses are reliably detected through the change in status of the reed switch 22. In particular, the reed switch 122 extends laterally across the circuit board 24 and is positioned in centrally on the printed circuit board 24.

The magnet 120 comprises a cylindrical neodymium magnet. The spindle 121 provides a cylindrical retaining recess 123 in an outer perimeter (circumferential) surface. The magnet 120 is retained in the recess 123 with an outer planar surface facing directly outwardly (tangentially orientated) from the outer peripheral surface. The cylindrical magnet 120 has a central longitudinal axis which extends along a radius of the spindle 121. The angular position of this longitudinal axis is arranged to move with the rotation of the spindle 121. For example, the longitudinal axis of the magnet 120 may move from a perpendicular orientation with the reed switch 122 to forming an acute angle (or 90 degrees or more) with the reed switch 122.

The reed 122 switch has a longitudinal axis which is arranged perpendicularly relative to the radius of the spindle 121. In the closed position, the longitudinal axis of the cylindrical magnet will dissect (or bisect) the reed switch 122 and the respective longitudinal axes will cross over each other (perpendicularly). In the open positon, the longitudinal axis of the cylindrical magnet is rotated and in the fully open position the longitudinal axis of the magnet 120 may be at an acute angle or may be parallel to the longitudinal axis of the reed switch 122. This ensures a reliable open and closing force for the reed switch 122 and reliably discriminates between the two states and provides an accurate status signal.

Accordingly, the first sensor will alert a user as to whether the locking (latching) mechanism is in a locked (latched) position or an unlocked (unlatched) position. As mentioned above, this does not guarantee that the window is in a closed position since the window sash may in fact be locked in an open position. The casement window handle assembly 10 thereby provides a second sensor comprising a first (window) sensor component mounted within the mounting base 14 and a second (window) sensor component is mounted on the window frame 112 itself. The sensor provides a proximity sensor which will demonstrate if the two sensor components are located adjacent to each other or are spaced apart which would indicate that the window sash 114 is in an open position within the window frame 112.

In the preferred embodiment, the mounting base 14 includes a second reed switch 132 mounted adjacent to one side on the printed circuit board 24. The casement window handle assembly 10 includes a discrete sensor component (housing) 31 which is arranged to be independently secured to the window frame 112 and houses a magnet 30 which is positioned to change the status of the reed switch 132 when the window sash 114 is closed within the window frame 112.

As with the first reed switch 122, the second reed 132 switch is located laterally across the printed circuit board 24. Both reed switches 122, 132 may be centrally located such that the handle is suitable for use in left hand and right hand windows, i.e. the reed switches 122, 132 are located midway between the lateral edges of the printed circuit board 24.

The further preferred embodiment, as shown in FIG. 8 to FIG. 15, may be based upon an existing casement window handle 12. The handle 12 has a 7 mm square spindle 121 bonded to it that rotates when the handle 12 is rotated. The spindle 121 is non-ferrous. There is a 4 mm hole 123 cross drilled through the spindle 121 that contains a 4 mm diameter neodymium magnet 120. The magnet 120 activates the reed switch 122 to detect whether the handle 12 is in the locked or unlocked position.

The second reed switch 132 is used to detect the position of the opening casement window. The magnet 30 is attached to the fixed casement window frame. The magnet 30 actuates the reed switch 132.

In some embodiments, signals from the reed switches 122, 132 are transmitted via Bluetooth to an Apple hub, and communicate with an Apple mobile phone APP.

The circuit is powered by 2×3v CR2032 batteries 170, 171 that are wired in parallel to double the capacity and extend battery life.

The batteries 170, 171 are user replaceable and are accessed by removing a battery hatch 174. Both batteries 170, 171 are held in an injection moulded cartridge 176 which can be lifted out of the assembly to facilitate battery changing.

On the front of the module are an LED 180 and an associated lens 181 and a small hole 182 through which a paper clip or the like can be used to ‘reset’ the circuit in case of a malfunction. The LED 180 flashes to indicate pairing status during Bluetooth set up. The LED 180 is positioned above the hole 182 for access to the reset switch 184.

The cast base of the handle assembly and the handle itself are manufactured from Zinc Alloy. The battery hatch 174 and the portion 175 of the case that sits over the Bluetooth module are manufactured from injection moulded plastic. The antenna on the Bluetooth module must not be obscured by metal parts that would prevent good propagation of the Bluetooth signal.

The casement window handle assembly 10 comprises communication means which is arranged to communicate the status of the two sensors to a user. For example, the window sensor may comprise a part of a home security system controlled by a single operating system to continuously monitor several windows, doors etc. at the same time. The communications system operates by using a WI-FI system (or Bluetooth) and a hub may be arranged to alert a user who may be located remotely in (or remotely away from) the Wi-Fi catchment area.

The casement window handle assembly 10 also comprises an impact sensor 60 in the form of a microelectromechanical system (MEMS) device which may comprise an accelerometer. The impact sensor 60 is arranged to detect shocks and repeated impacts which may signal an attack to the casement window handle and/or window. For example, the impact sensor 60 may detect repeated impacts which are not consistent with environmental factors (i.e. wind, weather etc.), adjacent building vibrations or normal opening forces.

As mentioned above, the casement window handle 10 comprises transmission means in order to communicate the status of the window 110 through the local Wi-Fi network and/or through Bluetooth. This signal may be communicated to a cloud server and then subsequently to the smartphone of the user. The casement window handle 10 may form one part of a home automation system including a number of sensors to enable a user to monitor the status of various devices and receive targeted alerts. Each casement window handle 10 is individually coded such that a software application (app) on the smartphone will be able to correctly identify the individual window 10, for example bedroom window.

The casement window handle 10 comprises a battery 70 and this battery may be inert until activated. In addition, the casement window handle 10 comprises communication means in the form of a Bluetooth module 72.

The present invention may be for use with existing casement window handles. Some handles may be replaced and some may be retrospectively altered in accordance with the present invention.

Overall, the present invention provides a window status sensor system which is solely operated by the position of the window handle 12 in combination with the position of the window sash 114 within the frame 112. This reduces the risk of obtaining a false positive in which a user may inadvertently believe that a window 110 was in the locked position when in fact the actual locking mechanism had not been correctly engaged.

1. A casement window handle comprising:
a mounting base, and
a window handle
wherein the window handle is movable between a latched position and an unlatched position, the mounting base being arranged to be mounted to part of a window sash movably mounted within a window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.

2. A casement window handle according to claim 1 in which the first handle component comprises a magnet.

3. A casement window handle according to claim 1 in which the rotatable member comprises a rotatable boss comprises a passageway defined therethrough which is arranged to engage an outer periphery of a spindle.

4. A casement window handle according to claim 1 in which the rotatable member comprises a spindle.

5. A casement window handle according to claim 3 in which a first end of the spindle is engaged with the window handle and a second end is engaged with a window sash locking mechanism.

6. A casement window handle according to claim 5 in which the window sash locking mechanism comprises an espagnolette lock.

7. A casement window handle according to claim 2 in which the rotatable member comprises a retaining recess within which the magnet is retained.

8. A casement window handle according to claim 7 in which the retaining recess is defined in an outer circumferential surface of the rotatable member.

9. A casement window handle according to claim 1 in which the second handle component comprise a reed switch.

10. A casement window handle according to claim 1 in which the first window component comprises a reed switch.

11. A casement window handle according to claim 1 in which the second window component comprises a magnet.

12. A casement window handle according to claim 11 in which the magnet is located within a discrete housing which is separate and independent of the window handle (mounting base).

13. A casement window handle according to claim 1 in which the casement window handle comprises communication means to communicate signals from each sensor to a remote unit and the communication means comprises a Bluetooth communication means.

14. A casement window handle according to claim 13 in which the communication means is arranged to be connected to a control hub and the control hub is connected to a router in order to further communicate the signal from the casement window handle.

15. A casement window handle according to claim 14 in which the control hub combines the signals received from both sensor to determine if the window sash is in a secure status or unsecured status wherein the secured status is identified when both sensors indicate that the window sash is closed within the window frame and the window handle is in a latched position and wherein the unsecured status is identified when either the window sash is open within the window frame or the window handle is in the unlatched position or both.

16. A casement window handle according to claim 1 in which the casement window handle comprises an impact sensor.

17. A casement window handle according to claim 16 in which the impact sensor is arranged to sense and detect an impact on the window and/or casement window handle.

18. A casement window handle according to claim 17 in which control means is arranged to receive the signals from the impact sensor and analyse the signal to identify an unauthorised attack and the control means monitors the frequency of signal received from the impact sensor and/or monitors the strength of impact received from the impact sensor.

19. A casement window handle according to claim 17 in which the control means monitors the time duration of signals received from the impact sensor.

20. A casement window handle according to claim 16 in which the impact sensor comprises a MEMS device comprising an accelerometer.

21. A casement window handle according to claim 1 in which the casement window handle comprises a housing comprising power means.

22. A casement window handle according to claim 21 in which the housing contains transmission means comprising a Bluetooth transmitter.

23. A window assembly comprising a window sash, a window frame and a casement window handle comprising:
a mounting base, and
a window handle
wherein the window handle is movable between a latched position and an unlatched position, the mounting base being arranged to be mounted to part of the window sash movably mounted within the window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.

24. A home automation system comprising at least one window status sensor system for monitoring a window including a casement window handle, the casement window handle comprising:
a mounting base, and
a window handle
wherein the window handle is movable between a latched position and an unlatched position, the mounting base being arranged to be mounted to part of a window sash movably mounted within a window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.

25. A method of providing a window status sensor system, in which the window includes a casement window handle, the casement window handle comprising:
a mounting base, and
a window handle
wherein the window handle is movable between a latched position and an unlatched position, the mounting base being arranged to be mounted to part of a window sash movably mounted within a window frame,
the casement window handle comprising a sensor system to indicate if the window sash is closed within the window frame and also if the window handle is in a latched position, the sensor system comprising:
a first sensor and a second sensor,
the first sensor comprising a first handle component mounted on a rotatable member of the window handle and a second handle component mounted within the mounting base in order to detect the window handle being in a latched position,
the second sensor comprising a first window component mounted in the mounting base and a second window component being arranged to be mounted on the window frame in order to detect the window sash being located in a closed position.
